(19) United States
(12) Patent Application Publication
(10) Pub. No.: US 2020/0090229 A1
(43) Pub. Date: Mar. 19, 2020

(54) System, Method, and Computer Program Product to Test a Campaign End-To-End Before Launch

(71) Applicant: Visa International Service Association, San Francisco, CA (US)

(72) Inventors: Gina Smith Pask, Bradenton, FL (US); Fabian Holger Hannemann, South Lake Tahoe, CA (US); Kshitij Banerjee, Singapore (SG); Mohit Durgapal, Singapore (SG); Mohit Kumar Gupta, Singapore (SG); Balathandapani Muthusamy, Singapore (SG)

(21) Appl. No.: 16/573,255

(22) Filed: Sep. 17, 2019

Related U.S. Application Data
(60) Provisional application No. 62/732,201, filed on Sep. 17, 2018.

(51) Int. Cl. G06Q 30/02

(52) U.S. Cl. CPC G06Q 30/0276; G06Q 30/0242; G06Q 30/0271

(57) ABSTRACT

A method for validating an active campaign before implementing the active campaign with at least one user includes generating a test user account, selecting at least one test user parameter for the test user account, generating a test campaign, selecting at least one test campaign parameter, initiating a test simulation of the test campaign using the test user account, determining whether the test user account satisfies the at least one test campaign parameter, and implementing an active campaign, which corresponds to the test campaign, by sending a message regarding the active campaign to the at least one user based on the test user account satisfying the at least one test campaign parameter.

### CROSS-REFERENCE TO RELATED APPLICATION

This application claims the benefit of U.S. Provisional Patent No. 62/732,201, filed on Sep. 17, 2018, the disclosure of which is incorporated by reference in its entirety.

### BACKGROUND

### 1. Field of the Disclosure

This disclosure relates generally to a campaign communication test system and, in one particular embodiment, to a method, system, and computer program product for implementing and testing a campaign end-to-end before launch.

### 2. Description of Related Art

Service providers often initiate campaigns to communicate account servicing messages, to promote new products, and to incentivize customers to take an action with regard to the campaign. Campaigns can include message that are to be distributed to customers using many different communication channels, including emails, texts, and hand mail, among other forms of communication. These messages (e.g., campaign messages) regarding the campaign are often sent to the users, who have provided specific information to a transaction service provider associated with the campaign, after a certain condition or event is triggered. For example, in the event a user makes a certain purchase with a merchant, an event is triggered to instruct the transaction service provider to initiate the creation and issuance of a new message regarding the campaign to be issued to the user. In the event a user makes a purchase of a certain item or of a certain value, the transaction service provider may issue a message regarding the campaign to the user identifying new and different checking accounts or credit cards that are available to the user.

If campaign parameters are not checked in advance of initiating a campaign, and confirmed they are set up successfully, a targeted record could be outside of the campaign parameters, causing an erroneous message to be sent to a recipient. Many marketing messages or campaigns contain errors due to the fact that the marketing message or campaigns are not tested with real and accurate information in place before being issued to the user. Real-time flow strategies for the campaign pose unique challenges, however. In a real-time flow, campaigns get triggered immediately following an event and testing all of the event combinations for the campaign can be challenging without a tool or system to create them as-needed and run them through a campaign management decision tree to ensure total accuracy. Real-time campaigns are especially difficult to test since a specific campaign is selected on-demand when any real-time event is triggered. Creating a new campaign requires that the new campaign is instantly added for selection and started serving the user that needs to be targeted. In the event the campaign is inaccurate, a campaign message may be sent to users with inaccurate information.

Therefore, in view of the foregoing, there is a current need for a campaign test system to provide end-to-end testing of campaign parameters to ensure the campaign is correct and accurately conveys the desired information to the user. There is also a current need for a system that is able to test campaigns without corrupting actual production data that is used with the campaign.

### SUMMARY

Accordingly, systems, devices, products, apparatus, and/or methods for testing a campaign to determine accuracy of campaign parameters provided in the campaign before issuance of the campaign to a user are disclosed that overcome some or all of the deficiencies of the prior art.

In one non-limiting embodiment of the present disclosure, a method for validating an active campaign before implementing the active campaign with at least one user may include generating, with at least one processor, a test user account; selecting, with at least one processor, at least one test user parameter for the test user account; generating, with at least one processor, a test campaign; selecting, with at least one processor, at least one test campaign parameter; initiating, with at least one processor, a test simulation of the test campaign using the test user account; determining, with at least one processor, whether the test user account satisfies the at least one test campaign parameter; and implementing an active campaign, which corresponds to the test campaign, by sending a message regarding the active campaign to the at least one user based on the test user account satisfying the at least one test campaign parameter.

In another non-limiting embodiment of the present disclosure, the at least one test user parameter may include at least one of the following: an account identification number of the test user account associated with a test user, a name of the test user, an email address of the test user, a phone number of the test user, a mailing address of the test user, opt-in information regarding the test user account, or any combination thereof. The at least one test campaign parameter may include at least one of the following: a token number, a token requestor, a token status for the test user account, or any combination thereof. Generating the test user account may include generating the test user account based on receiving a notification that a pre-determined event has been satisfied. The method may further include generating at least one status report regarding the test simulation of the test campaign; and communicating the at least one status report to a user device based on generating the at least one status report. The method may further include generating a status report that includes data associated with an indication of whether any errors were detected during the test simulation. In the event an error is identified during the test simulation, a report may be issued, by the at least one processor, to indicate where the error occurred during the test simulation and a potential cause of the error.

In another non-limiting embodiment of the present disclosure, a system for validating an active campaign before implementing the active campaign with at least one user, may include at least one processor programmed or configured to: generate a test user account; select at least one test user parameter for the test user account; generate a test campaign; select at least one test campaign parameter; initiate a test simulation of the test campaign using the test user account; determine whether the test user account satisfies the at least one test campaign parameter; and implement an active campaign, which corresponds to the test campaign, by sending a message regarding the active campaign to the at least one user based on the test user account satisfying the at least one test campaign parameter.

In another non-limiting embodiment of the present disclosure, the at least one test user parameter may include at least one of the following: an account identification number of the test user account associated with a test user, a name of the test user, an email address of the test user, a phone number of the test user, a mailing address of the test user, opt-in information regarding the test user account, or any combination thereof. The least one test campaign parameter may include at least one of the following: a token number, a token requestor, a token status for the test user account, or any combination thereof. Generating the test user account may include: generating the test user account based on receiving a notification that a pre-determined event has been satisfied. The system may further be programmed and/or configured to generate at least one status report regarding the test simulation of the test campaign; and communicate the at least one status report to a user device based on generating the at least one status report. The system may further be programmed and/or configured to generate a status report that includes data associated with an indication of whether any errors were detected during the test simulation. In the event an error is identified during the test simulation, a report may be issued, by the at least one processor, to indicate where the error occurred during the test simulation and a potential cause of the error.

In another non-limiting embodiment of the present disclosure, a computer program product for validating an active campaign before implementing the active campaign with at least one user, may include at least one non-transitory computer-readable medium including program instructions that, when executed by at least one processor, may cause the at least one processor to: generate, with the at least one processor, a test user account; select, with the at least one processor, at least one test user parameter for the test user account; generate, with the at least one processor, a test campaign; select, with the at least one processor, at least one test campaign parameter; initiate, with the at least one processor, a test simulation of the test campaign using the test user account; determine, with the at least one processor, whether the test user account satisfies the at least one test campaign parameter; and implement an active campaign, which corresponds to the test campaign, by sending a message regarding the active campaign to the at least one user based on the test user account satisfying the at least one test campaign parameter.

In another non-limiting embodiment of the present disclosure, the at least one test user parameter may include at least one of the following: an account identification number of the test user account associated with a test user, a name of the test user, an email address of the test user, a phone number of the test user, a mailing address of the test user, opt-in information regarding the test user account, or any combination thereof. The at least one test campaign parameter may include at least one of the following: a token number, a token requestor, a token status for the test user account, or any combination thereof. Generating the test user account may include: generating the test user account based on receiving a notification that a pre-determined event has been satisfied. The at least one processor may generate at least one status report regarding the test simulation of the test campaign; and communicate the at least one status report to a user device based on generating the at least one status report. The at least one processor may generate a status report that includes data associated with an indication of whether any errors were detected during the test simulation.

The features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a non-limiting embodiment of an environment in which systems, apparatuses, and/or methods, as described herein, may be implemented;

FIG. 2 is a diagram of a non-limiting embodiment of components of one or more devices of FIG. 1;

FIG. 3 is a flowchart illustrating a non-limiting embodiment of a method for validating an active campaign before implementing the active campaign with at least one user;

FIG. 4A-4G are diagrams of a non-limiting embodiment of the method illustrated in FIG. 3.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the terms “issuer institution,” “portable payment device issuer,” “issuer,” or “issuer bank” may refer to one or more entities that provide accounts to users for conducting transactions (e.g., payment transactions), such as initiating credit and/or debit payments. For example, an issuer institution may provide an account identifier, such as a personal account number (PAN), to a user that uniquely identifies one or more accounts associated with that user. The account identifier may be embodied on a portable payment device, such as a physical financial instrument (e.g., a payment card), and/or may be electronic and used for electronic payments. In some non-limiting embodiments, an issuer institution may be associated with a bank identification number (BIN) that uniquely identifies the issuer institution. As used herein “issuer institution system” may refer to one or more computer systems operated by or on behalf of an issuer institution, such as a server executing one or more software applications. For example, an issuer institution system may include one or more authorization servers for authorizing a transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user (e.g., a user, a consumer, and/or the like) based on a transaction, such as a payment transaction. As used herein “merchant system” may refer to one or more computer systems operated by or on behalf of a merchant, such as a server executing one or more software applications. As used herein, the term “product” may refer to one or more goods and/or services offered by a merchant.

As used herein, a “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, a “POS system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “acquirer” may refer to an entity licensed by the transaction service provider and approved by the transaction service provider to originate transactions (e.g., payment transactions) using a portable payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a portable payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “portable payment device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant (PDA), a pager, a security card, a computer, an access card, a wireless terminal, and/or a transponder, as examples. The portable payment device may include a volatile or a non-volatile memory to store information (e.g., an account identifier, a name of the account holder, and/or the like).

As used herein, the terms “client” and “client device” may refer to one or more client-side devices or systems, remote from a transaction service provider, used to initiate or facilitate a transaction. As an example, a “client device” may refer to one or more POS devices and/or POS systems used by a merchant. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), PDAs, and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices. It will be appreciated that various other arrangements are possible. As used herein, the term “system” may refer to one or more computing devices or combinations of computing devices, such as but not limited to processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present disclosure are directed to systems, methods, and computer program products for validating an active campaign before implementing the active campaign with at least one user. In some non-limiting embodiments, a method includes generating a test user account, selecting at least one test user parameter for the test user account, generating a test campaign, selecting at least one test campaign parameter, initiating a test simulation of the test campaign using the test user account, determining whether the test user account satisfies the at least one test campaign parameter, and implementing the active campaign, which corresponds to the test campaign, by sending a message regarding the campaign to the at least one user based on the test user account satisfying the at least one test campaign parameter.

In this way, embodiments of the present disclosure are effective at providing a system that merchants and transaction service providers can use to create test campaigns using test parameters to ensure the information provided to users with the campaign is accurate throughout the entire campaign management flow between the transaction service provider and the user. The testing system can ensure the campaign management flow operates correctly, from initial decision trees with the campaign to running the campaign through the entire campaign management flow. The embodiments of the present disclosure accurately determine a campaign for an account of a user, which can be used to determine an offer that is to be communicated to the user that is effective at encouraging the user to conduct a payment transaction involving the merchant. Accordingly, a transaction service provider, a financial institution, and/or a merchant may cause an offer to be communicated to the user that is effective at encouraging the user to conduct a payment transaction involving the merchant. In this way, embodiments of the present disclosure may reduce consumption of network resources and processing resources associated with communicating an offer to the user based on a determination that a user is likely to conduct a payment transaction involving a merchant as compared to communicating an offer to the one or more users independent of determining a market campaign.

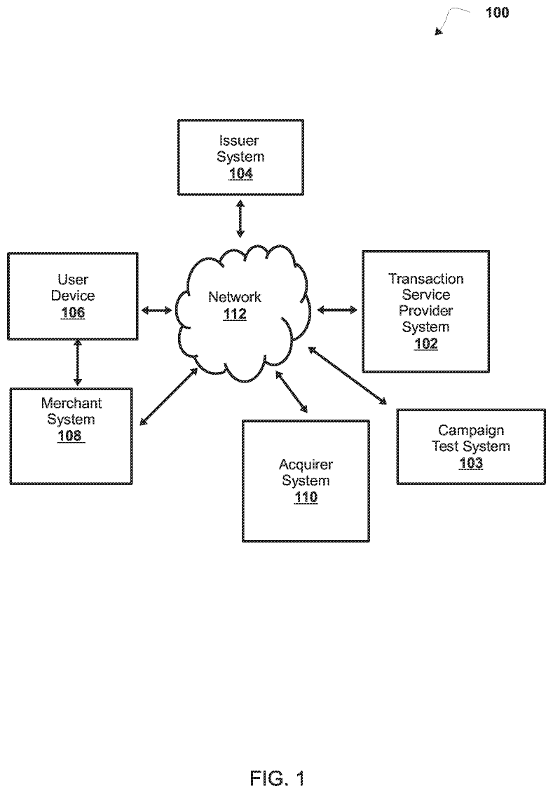

Referring now to FIG. 1, FIG. 1 is a diagram of an example environment 100 in which devices, systems, and/or methods, described herein, may be implemented. As shown in FIG. 1, environment 100 includes transaction service provider system 102, campaign test system 103, issuer system 104, user device 106, merchant system 108, acquirer system 110, and network 112.

Transaction service provider system 102 may include one or more devices capable of receiving information from and/or communicating information to campaign test system 103, issuer system 104, user device 106, merchant system 108, and/or acquirer system 110 via network 112. For example, transaction service provider system 102 may include a computing device, such as a server (e.g., a transaction processing server), a group of servers, and/or other like devices. In some non-limiting embodiments, transaction service provider system 102 may be associated with a transaction service provider as described herein. In some non-limiting embodiments, transaction service provider system 102 may be in communication with a data storage device, which may be local or remote to the transaction service provider system 102. In some non-limiting embodiments, transaction service provider system 102 may be capable of receiving information from, storing information in, communicating information to, or searching information stored in a data storage device. The transaction service provider system 102 may also include a campaign test system 103 for generating and initiating testing and validation of a campaign to be sent to users. It is also contemplated that the campaign test system 103 may be provided in any other component of the environment 100 including, but not limited to, the issuer system 104, the merchant system 108, and the acquirer system 110.

Campaign test system 103 may include one or more devices capable of receiving information and/or communicating information to transaction service provider system 102, user device 106, merchant system 108, and/or acquirer system 110 via network 112. For example, campaign test system 103 may include a computing device, such as a server, a group of servers, and/or other like devices. In some non-limiting embodiments, campaign test system 103 may be associated with issuer system 104, user device 106, merchant system 108, and/or acquirer system 110 via network 112. In some non-limiting embodiments, campaign test system 103 may be a component of transaction service provider system 102.

Issuer system 104 may include one or more devices capable of receiving information and/or communicating information to transaction service provider system 102, user device 106, merchant system 108, and/or acquirer system 110 via network 112. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, campaign test system 103, issuer system 104, merchant system 108, and/or acquirer system 110 via network 112. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or communicating information (e.g., to merchant system 108) via a short range wireless communication connection.

Merchant system 108 may include one or more devices capable of receiving information from and/or communicating information to transaction service provider system 102, campaign test system 103, issuer system 104, user device 106, and/or acquirer system 110 via network 112. Merchant system 108 may also include a device capable of receiving information from user device 106 via network 112, a communication connection (e.g., an NFC communication connection, an RFID communication connection, a Bluetooth® communication connection, and/or the like) with user device 106, and/or the like, and/or communicating information to user device 106 via the network, the communication connection, and/or the like. In some non-limiting embodiments, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or communicating information to transaction service provider system 102, campaign test system 103, issuer system 104, user device 106, and/or merchant system 108 via network 112. For example, acquirer system 110 may include a computing device, a server, a group of servers, and/or the like. In some non-limiting embodiments, acquirer system 110 may be associated with an acquirer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

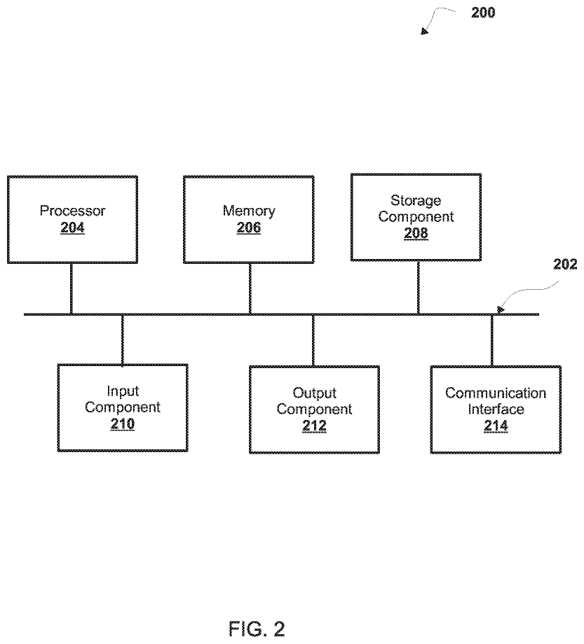

Referring now to FIG. 2, FIG. 2 is a diagram of example components of a device 200. Device 200 may correspond to one or more devices of transaction service provider system 102, and/or one or more devices of campaign test system 103, issuer system 104, user device 106, one or more devices of merchant system 108, and/or one or more devices of acquirer system 110. In some non-limiting embodiments, transaction service provider system 102, campaign test system 103, issuer system 104, user device 106, merchant system 108, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

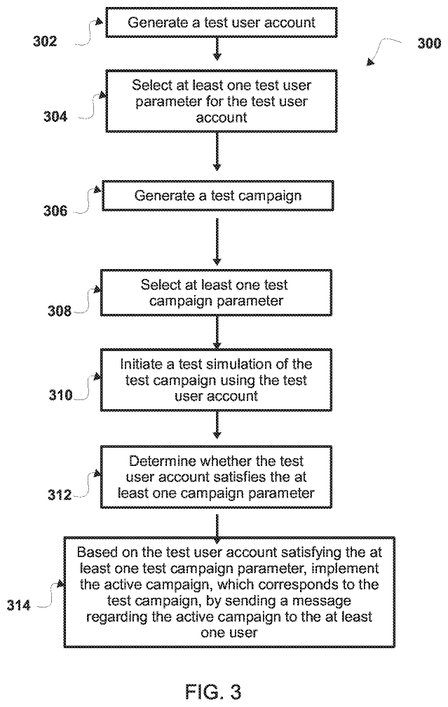

Referring now to FIG. 3, FIG. 3 is a flowchart of a non-limiting embodiment of a process 300 for validating an active campaign before implementing the active campaign with at least one user by sending a message regarding the campaign to the at least one user. In some non-limiting embodiments, one or more of the steps of process 300 may be performed (e.g., completely, partially, etc.) by transaction service provider system 102 (e.g., one or more devices of transaction service provider system 102). In some non-limiting embodiments, one or more of the steps of process 300 may be performed (e.g., completely, partially, etc.) by another device or a group of devices separate from or including transaction service provider system 102, such as campaign test system 103 (e.g., one or more devices of campaign test system 103), issuer system 104 (e.g., one or more devices of issuer system 104), user device 106, merchant system 108 (e.g., one or more devices of merchant system 108), or acquirer system 110 (e.g., one or more devices of acquirer system 110).

As shown in FIG. 3, at step 302, process 300 includes generating a test user account. The test user account may be generated upon campaign test system 103 receiving notification that a pre-determined event, such as a user making a certain purchase or spending a certain amount of funds, has been satisfied by the user. For example, campaign test system 103 may generate a test user account that includes at least one of the following test user parameters: an account identification number, a name, an email address, a phone number, a mailing address, and/or opt-in information regarding the test user's account. In some non-limiting embodiments, the opt-in information may be test user parameters set by a tester (e.g., a user of campaign test system 103) that indicate whether the test user has opted in to receiving emails, direct mail, and/or text messages from the transaction service provider. Additionally or alternatively, the test user parameters may indicate whether the test user has opted in to receiving marketing emails, direct mail marketing materials, and/or marketing text messages.

As further shown in FIG. 3, at step 304, process 300 includes selecting at least one test user parameter for the test user account. In some non-limiting embodiments, the tester may select a plurality of different test user parameters that correspond to the specific campaign that is to be validated. The test user parameters can be manipulated by the tester to test different campaigns in view of specific test user account conditions.

As further shown in FIG. 3, at step 306, process 300 includes generating a test campaign (e.g., a test communication campaign). In some non-limiting embodiments, campaign test system 103 generates a test campaign based on parameters selected by the tester. The tester is able to select and generate different test campaigns that are to be validated by the campaign test system 103.

As further shown in FIG. 3, at step 308, process 300 includes selecting at least one test campaign parameter for the test campaign. In some non-limiting embodiments, test campaign parameters may include token provisioning parameters including token numbers, token requestors, and token statuses for the test user. The token requesters may include Google Pay™ (which may also be called Android Pay™), Apple Pay™, and/or the like. In some non-limiting embodiments, the token statuses may include whether a token has been created, whether a token is active, and/or whether a token is inactive.

As further shown in FIG. 3, at step 310, process 300 includes initiating a test simulation of the test campaign using the test user account. In some non-limiting embodiments, campaign test system 103 is used to initiate a test simulation of the test campaign in view of the test user account that was created by the tester. Based on the test user parameters and the test campaign parameters selected by the tester, the campaign test system 103 will run a simulation to ensure that an accurate message regarding the campaign would be issued to the test user.

As further shown in FIG. 3, at step 312, process 300 includes determining whether the test user account satisfies the at least one test campaign parameter. In the event an error is identified during the simulation by campaign test system 103, a report is issued to the tester to indicate where the error occurred during the simulation and the potential cause of the error. By running the simulation, campaign test system 103 may determine that all token events have been satisfied, that the test user is eligible for the campaign, that the token requestor is satisfied, and/or the test user information is accurate. For example, during a simulation, campaign test system 103 may identify an error during a phase in which the token requestor is validated, which would indicate that the test user has Apple Pay™, but the test campaign is to be directed to Google Pay™ users.

After the error has been identified by the tester and/or campaign test system 103, an additional simulation of the test campaign may be initiated by campaign test system 103 to ensure no additional errors exist in the campaign. For example, in a second simulation, campaign test system 103 may identify that the token requestor is now correct, but the token status is listed as inactive. Therefore, since the test campaign parameters may include the token status as being active, campaign test system 103 will indicate that an additional error has been identified when running the second simulation of the test campaign. Campaign test system 103 may issue a second subsequent error report to indicate to the tester that an error has occurred during the simulation and a correction to the test campaign needs to be made. In a similar fashion, the tester can continue to run simulations of the test campaign until no error are detected during the simulation. Each time an error is identified by campaign test system 103, the tester can modify the test campaign to correct the error and continue to run simulations until each error has been corrected. Each time a simulation is run by campaign test system 103, campaign test system 103 will generate and communicate a status report regarding the simulation. In some non-limiting embodiments, the status report may include data associated with an indication of whether any errors were detected during the simulation. The status report may specifically identify at which step of the simulation the error was encountered so the tester can easily identify and correct this error.

As further shown in FIG. 3, at step 314, process 300 includes, based on the test user account satisfying the at least one test campaign parameter, implementing an active campaign (e.g., an active communication campaign) that includes a message regarding the active campaign to be sent to at least one user, which corresponds to the test campaign that was tested during the simulations. After campaign test system 103 has indicated that no errors were detected during the simulation of the test campaign and the tester is satisfied with the test campaign parameters that have been set for the test campaign, the tester can instruct campaign test system 103 to implement an active campaign that includes a message regarding the active campaign that is to be sent to a user based on the same campaign parameters that were selected for the test campaign. By running the simulation(s) of the test campaign before implementing the active campaign and sending messages regarding the active campaign to the user(s), the tester can ensure that no errors are included in the active campaign or the message(s) regarding the active campaign so that accurate information is conveyed to the user(s).

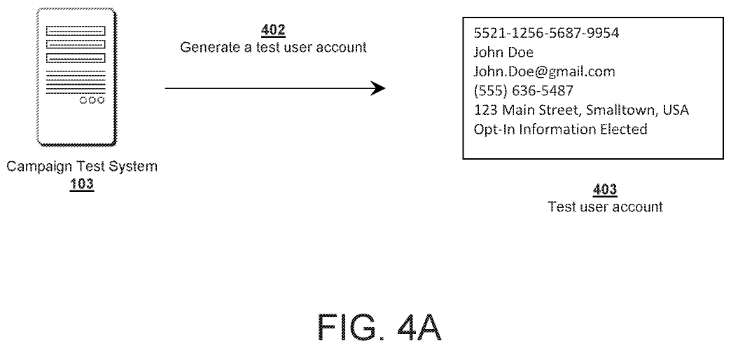

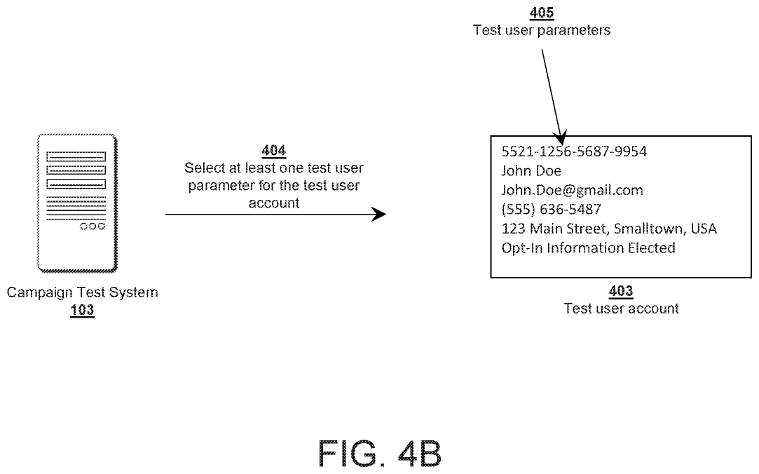

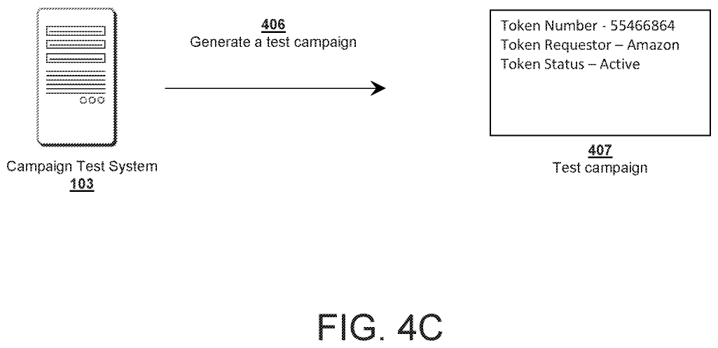

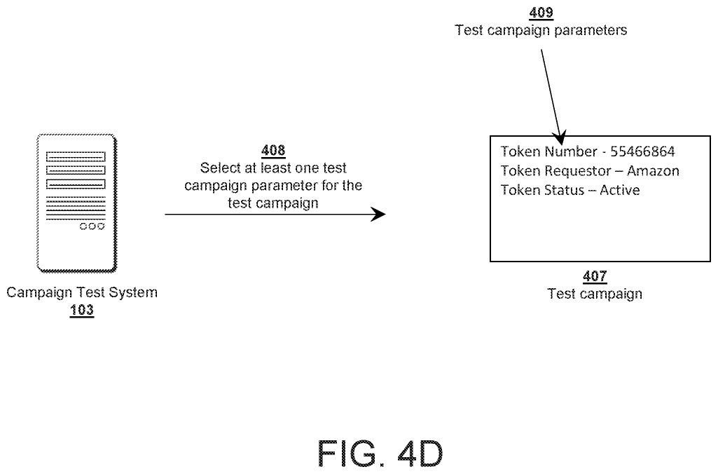

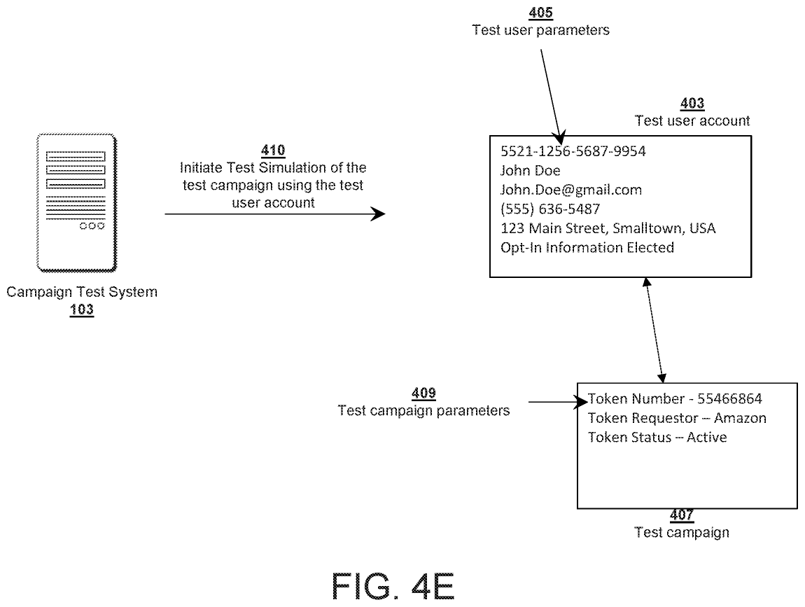

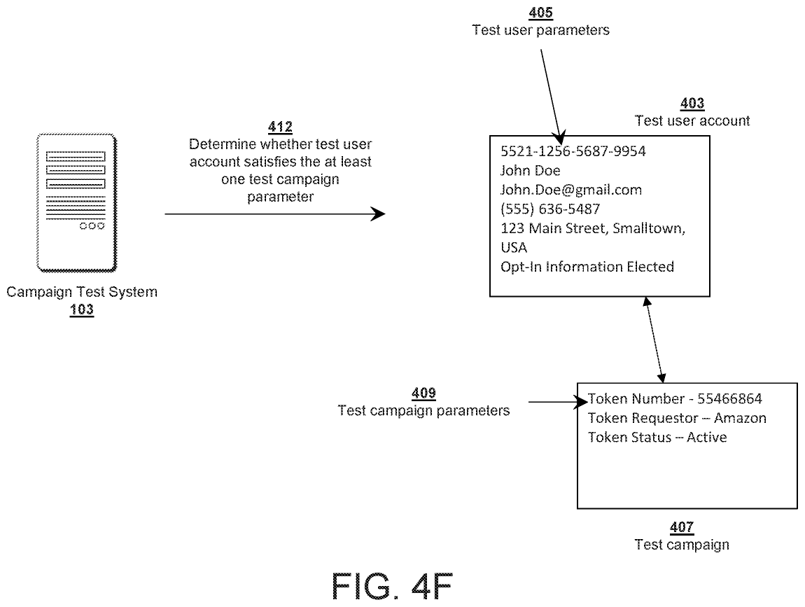

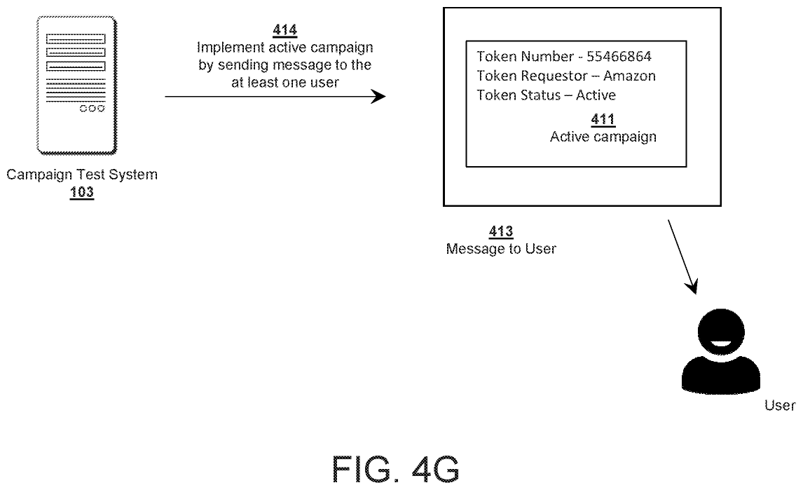

FIGS. 4A-4G are diagrams of an overview of a non-limiting embodiment of an implementation relating to process 300 shown in FIG. 3. As shown in FIGS. 4A-4G, implementation may include campaign test system 103.

As shown in FIG. 4A, the campaign test system 103 may generate a test user account 402, 403. The test user account may be generated upon campaign test system 103 receiving notification that a pre-determined event, such as a user making a certain purchase or spending a certain amount of funds, has been satisfied by the user.

As shown in FIG. 4B, the campaign test system 103 may select at least one test user parameter 405 for the test user account 403, 404. For example, campaign test system 103 may generate a test user account 403 that includes at least one of the following test user parameters 405: an account identification number, a name, an email address, a phone number, a mailing address, and/or opt-in information regarding the test user's account. In some non-limiting embodiments, the opt-in information may be test user parameters set by a tester (e.g., a user of campaign test system 103) that indicate whether the test user has opted in to receiving emails, direct mail, and/or text messages from the transaction service provider. Additionally or alternatively, the test user parameters 405 may indicate whether the test user has opted in to receiving marketing emails, direct mail marketing materials, and/or marketing text messages. In some non-limiting embodiments, the tester may select a plurality of different test user parameters 405 that correspond to the specific campaign that is to be validated. The test user parameters 405 can be manipulated by the tester to test different campaigns in view of specific test user account conditions.

As shown in FIG. 4C, the campaign test system 103 may generate a test campaign 406, 407. In some non-limiting embodiments, campaign test system 103 generates a test campaign 407 based on parameters selected by the tester. The tester is able to select and generate different test campaigns 407 that are to be validated by the campaign test system 103.

As shown in FIG. 4D, the campaign test system 103 may select at least one test campaign parameter 409 for the test campaign 407, 408. In some non-limiting embodiments, test campaign parameters 409 may include token provisioning parameters including token numbers, token requestors, and token statuses for the test user. The token requesters may include Google Pay™ (which may also be called Android Pay™), Apple Pay™, and/or the like. In some non-limiting embodiments, the token statuses may include whether a token has been created, whether a token is active, and/or whether a token is inactive.

As shown in FIG. 4E, the campaign test system 103 may initiate a test simulation of the test campaign 407 using the test user account 403, 410. In some non-limiting embodiments, campaign test system 103 is used to initiate a test simulation of the test campaign 407 in view of the test user account 403 that was created by the tester. Based on the test user parameters 405 and the test campaign parameters 409 selected by the tester, the campaign test system 103 will run a simulation to ensure that an accurate message regarding the campaign would be issued to the test user.

As shown in FIG. 4F, the campaign test system 103 may determine whether the test user account 403 satisfies the at least one test campaign parameter 409, 412. In the event an error is identified during the simulation by campaign test system 103, a report is issued to the tester to indicate where the error occurred during the simulation and the potential cause of the error. By running the simulation, campaign test system 103 may determine that all token events have been satisfied, that the test user is eligible for the campaign, that the token requestor is satisfied, and/or the test user information is accurate. For example, during a simulation, campaign test system 103 may identify an error during a phase in which the token requestor is validated, which would indicate that the test user has Apple Pay™, but the test campaign is to be directed to Google Pay™ users.

After the error has been identified by the tester and/or campaign test system 103, an additional simulation of the test campaign 407 may be initiated by campaign test system 103 to ensure no additional errors exist in the campaign. For example, in a second simulation, campaign test system 103 may identify that the token requestor is now correct, but the token status is listed as inactive. Therefore, since the test campaign parameters 409 may include the token status as being active, campaign test system 103 will indicate that an additional error has been identified when running the second simulation of the test campaign 407. Campaign test system 103 may issue a second subsequent error report to indicate to the tester that an error has occurred during the simulation and a correction to the test campaign 407 needs to be made. In a similar fashion, the tester can continue to run simulations of the test campaign 407 until no error are detected during the simulation. Each time an error is identified by campaign test system 103, the tester can modify the test campaign 407 to correct the error and continue to run simulations until each error has been corrected. Each time a simulation is run by campaign test system 103, campaign test system 103 will generate and communicate a status report regarding the simulation. In some non-limiting embodiments, the status report may include data associated with an indication of whether any errors were detected during the simulation. The status report may specifically identify at which step of the simulation the error was encountered so the tester can easily identify and correct this error.

As shown in FIG. 4G, the campaign test system 103 may implement an active campaign 411 by sending a message 413 to the at least one user 414. After campaign test system 103 has indicated that no errors were detected during the simulation of the test campaign 407 and the tester is satisfied with the test campaign parameters 409 that have been set for the test campaign 407, the tester can instruct campaign test system 103 to implement an active campaign 411 that includes a message 413 regarding the active campaign 411 that is to be sent to a user based on the same campaign parameters that were selected for the test campaign 407. By running the simulation(s) of the test campaign 407 before implementing the active campaign 411 and sending messages 413 regarding the active campaign 411 to the user(s), the tester can ensure that no errors are included in the active campaign 411 or the message(s) 413 regarding the active campaign 411 so that accurate information is conveyed to the user(s).

Although the present disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claim. For example, it is to be understood that the present disclosure contemplates that, to the extent possible, one or more features of any embodiment can be combined with one or more features of any other embodiment. Additional details regarding non-limiting embodiments of the present disclosure may be found in the attached Appendix.

What is claimed is:

1. A method for validating an active campaign before implementing the active campaign with at least one user, comprising:
generating, with at least one processor, a test user account;
selecting, with at least one processor, at least one test user parameter for the test user account;
generating, with at least one processor, a test campaign;
selecting, with at least one processor, at least one test campaign parameter;
initiating, with at least one processor, a test simulation of the test campaign using the test user account;
determining, with at least one processor, whether the test user account satisfies the at least one test campaign parameter; and
implementing an active campaign, which corresponds to the test campaign, by sending a message regarding the active campaign to the at least one user based on the test user account satisfying the at least one test campaign parameter.

2. The method of claim 1, wherein the at least one test user parameter comprises at least one of the following:
an account identification number of the test user account associated with a test user,
a name of the test user,
an email address of the test user,
a phone number of the test user,
a mailing address of the test user,
opt-in information regarding the test user account, or
any combination thereof.

3. The method of claim 1, wherein the at least one test campaign parameter comprises at least one of the following:
a token number,
a token requestor,
a token status for the test user account, or
any combination thereof.

4. The method of claim 1, wherein generating the test user account comprises:
generating the test user account based on receiving a notification that a pre- determined event has been satisfied.

5. The method of claim 1, further comprising:
generating at least one status report regarding the test simulation of the test campaign; and
communicating the at least one status report to a user device based on generating the at least one status report.

6. The method of claim 1, further comprising:
generating a status report that includes data associated with an indication of whether any errors were detected during the test simulation.

7. The method of claim 1, wherein, in the event an error is identified during the test simulation, a report is issued, by the at least one processor, to indicate where the error occurred during the test simulation and a potential cause of the error.

8. A system for validating an active campaign before implementing the active campaign with at least one user, comprising at least one processor programmed or configured to:
generate, with the at least one processor, a test user account;
select, with the at least one processor, at least one test user parameter for the test user account;
generate, with the at least one processor, a test campaign;
select, with the at least one processor, at least one test campaign parameter;
initiate, with the at least one processor, a test simulation of the test campaign using the test user account;
determine, with the at least one processor, whether the test user account satisfies the at least one test campaign parameter; and
implement an active campaign, which corresponds to the test campaign, by sending a message regarding the active campaign to the at least one user based on the test user account satisfying the at least one test campaign parameter.

9. The system of claim 8, wherein the at least one test user parameter comprises at least one of the following:
an account identification number of the test user account associated with a test user,
a name of the test user,
an email address of the test user,
a phone number of the test user,
a mailing address of the test user,
opt-in information regarding the test user account, or
any combination thereof.

10. The system of claim 8, wherein the at least one test campaign parameter comprises at least one of the following:
a token number,
a token requestor,
a token status for the test user account, or
any combination thereof.

11. The system of claim 8, wherein generating the test user account comprises:
generating the test user account based on receiving a notification that a pre-determined event has been satisfied.

12. The system of claim 8, wherein the at least one processor is further programmed or configured to:
generate at least one status report regarding the test simulation of the test campaign; and
communicate the at least one status report to a user device based on generating the at least one status report.

13. The system of claim 8, wherein the at least one processor is further programmed or configured to:
generate a status report that includes data associated with an indication of whether any errors were detected during the test simulation.

14. The system of claim 8, wherein, wherein the at least one processor is further programmed or configured to:
in the event an error is identified during the test simulation, generate a report to indicate where the error occurred during the test simulation and a potential cause of the error.

15. A computer program product for validating an active campaign before implementing the active campaign with at least one user, comprising at least one non-transitory computer-readable medium including program instructions that, when executed by at least one processor, cause the at least one processor to:
generate, with the at least one processor, a test user account;
select, with the at least one processor, at least one test user parameter for the test user account;
generate, with the at least one processor, a test campaign;
select, with the at least one processor, at least one test campaign parameter;
initiate, with the at least one processor, a test simulation of the test campaign using the test user account;
determine, with the at least one processor, whether the test user account satisfies the at least one test campaign parameter; and
implement an active campaign, which corresponds to the test campaign, by sending a message regarding the active campaign to the at least one user based on the test user account satisfying the at least one test campaign parameter.

16. The computer program product of claim 15, wherein the at least one test user parameter comprises at least one of the following:
an account identification number of the test user account associated with a test user,
a name of the test user,
an email address of the test user,
a phone number of the test user,
a mailing address of the test user,
opt-in information regarding the test user account, or
any combination thereof.

17. The computer program product of claim 15, wherein the at least one test campaign parameter comprises at least one of the following:
a token number,
a token requestor,
a token status for the test user account, or
any combination thereof.

18. The computer program product of claim 15, wherein generating the test user account comprises:
generating the test user account based on receiving a notification that a pre-determined event has been satisfied.

19. The computer program product of claim 15, further comprising:
generating at least one status report regarding the test simulation of the test campaign; and
communicating the at least one status report to a user device based on generating the at least one status report.

20. The computer program product of claim 15, further comprising:
generating a status report that includes data associated with an indication of whether any errors were detected during the test simulation.
